(19) United States
(12) Patent Application Publication
(10) Pub. No.: US 2006/0103256 A1
(43) Pub. Date: May 18, 2006

(54) Laminated core of a stator and/or of a rotor of a splash-cooled electrical machine as well as a splash-cooled electrical machine

(75) Inventor: Knut Welke, Falkensee/Waldheim (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/274,806

(22) Filed: Nov. 15, 2005

(30) Foreign Application Priority Data
Nov. 16, 2004 (DE) 10 2004 055 179.0

(51) Int. Cl. H02K 5/00

(52) U.S. Cl. 310/216; 310/89; 310/91; 310/261

(57) ABSTRACT

A laminated core of a stator and/or rotor for a splash-cooled electrical machine, where the stator and/or rotor are mounted inside the housing of the splash-cooled electrical machine. The laminated core has a main body in the form of a hollow cylinder, and means on at least one end surface thereof by which the laminated core can be attached to the inside surface of the housing of the splash-cooled electrical machine or to a rotor bracket of the rotor. In addition, a splash-cooled electrical machine comprises a housing with oil outlets; a stator, which is mounted inside the housing and has a hollow cylindrical laminated stator core; a rotor, which is mounted inside the housing and is supported with freedom of rotation with respect to the stator and has a hollow cylindrical laminated core; and a shaft, which has a device for injecting oil into the interior of the housing of the electrical machine. The stator or the rotor has an inventive laminated core.

### BACKGROUND OF THE INVENTION

1. Field of the Invention

The present invention relates to a laminated core of a stator and/or of a rotor of a splash-cooled electrical machine, where the stator and the rotor are mounted inside a housing of the splash-cooled electrical machine. The laminated core has a main body in the form of a hollow cylinder. The invention also relates to a splash-cooled electrical machine having a housing with oil outlets; a stator, which is mounted inside the housing and has a hollow cylindrical laminated core; a rotor, which is mounted inside the housing and supported with freedom to rotate with respect to the stator, and has a hollow cylindrical laminated core; and a shaft with a device for injecting oil into the interior of the housing of the electrical machine.

2. Description of the Related Art

Electrical machines are used to generate, to use, or to transmit electrical energy. Electrical machines can be divided into direct-current machines and three-phase machines. Three-phase machines can be further divided in turn into synchronous and asynchronous machines. The efficiencies of all three types of electrical machines are reduced by copper losses, by iron losses, and by frictional losses. For example, the copper losses are caused by the ohmic resistance of the windings, the iron losses by hysteresis and eddy currents, and the frictional losses by bearing friction or aerodynamic friction. All of the power losses are converted into heat, which must be carried away to the outside. The aging resistance and performance of electrical machines depend to a large extent on the intensity with which the machine or its components such as the stator and the rotor are cooled. An efficient cooling system is required to obtain high output, especially from a machine of small size, for example. The stator or the rotor comprises a bracket, a laminated core, and windings, which pass around the core. The laminated core of the rotor and especially the laminated core of the stator must be cooled intensively.

Various solutions for cooling the stator and the rotor of electrical machines, especially of the laminated cores of the rotor and stator, are known in the prior art. It is known, for example, that the stator can be cooled by water, which is conducted through channels. The disadvantage here is that the channels must be sealed off by complicated seals. When water is used for cooling, furthermore, only castings are suitable—no sheet metal parts can be used. Another disadvantage of this type of cooling is that a second medium is required when the electrical machine is installed in a gearbox, but only oil is allowed in the gearbox. This increases costs. It is also known that the laminated cores of the stator and the rotor can be splash-cooled with oil. This solution is simpler and less expensive. The disadvantage, however, is that oil absorbs the heat less effectively than water.

An electrical machine is known from U.S. Pat. No. 6,148,784 which is cooled internally with oil. After the oil has passed through a cooler and a pump, it is splashed onto the rotor. As a result of the rotation of the rotor, the oil migrates outward under centrifugal force and thus cools the rest of the rotor and the stator. Outlets through which the oil leaves the interior of the electrical machine are provided in the housing so that the oil can be sent back to the cooler in a closed circuit. Each of the rotor and the stator has windings, a laminated core, and a bracket. In this type of splash-cooled electrical machine, the stator's laminated core and the rotor's laminated core are in the form of hollow cylinders.

A splash-cooled electrical machine according to the prior art is illustrated schematically in FIG. 1. The stator, equipped with a stator bracket, a laminated core, and windings on the sides of the laminated core, and the rotor, equipped with a rotor bracket, a laminated core, and windings around the lateral surface of its laminated core, are mounted inside the housing of the splash-cooled electrical machine. The shaft to which the rotor is attached ensures that the rotor can rotate around the stator. The shaft has a device for injecting oil. The oil strikes the stator bracket, runs along the bracket it until it reaches the openings in the sides of the stator bracket, and proceeds from there to the rotor and to the outlets in the housing. The disadvantage of this type of machine is that the laminated core of the rotor and especially the laminated core of the stator can be cooled to only a limited extent. In the case of the splash-cooled electrical machine shown in FIG. 1, the laminated core of the stator and the laminated core of the rotor are attached by their lateral surfaces to their respective brackets. That is, the stator's laminated core is attached by its inner lateral surface to the stator bracket, and the rotor's laminated core is attached by its outer lateral surface to the rotor bracket. The stator bracket and the rotor bracket are thus located between the laminated cores and the coolant. The heat which develops in the laminated cores cannot be dissipated directly from the laminated cores to the coolant, that is, to the injected oil; instead, it must first be transferred to the stator bracket and to the rotor bracket. When the laminated cores of a splash-cooled electrical machine are attached to the stator bracket and to the rotor bracket in the manner known from the prior art, therefore, the laminated cores can be cooled to only a limited extent, which leads to impairment of the performance and decreases the aging resistance of these splash-cooled electrical machines.

### SUMMARY OF THE INVENTION

An object of the invention is to create a laminated core for the stator and/or for the rotor of a splash-cooled electrical machine, which is designed in such a way that the laminated core of the stator and/or of the rotor can be cooled more effectively. In addition, another object is to create a simpler and more powerful splash-cooled electrical machine.

These objects are accomplished by a laminated core and by a splash-cooled electrical machine of the invention. Additional advantages, features, and details of the invention can be derived from the embodiments, the description, and the drawings. Features and details which are described in conjunction with the inventive laminated core are also applicable, as should be obvious, to the inventive electrical machine and vice versa.

A laminated core of a stator and/or of a rotor (which stator/rotor are mounted inside the housing of a splash-cooled electrical machine) comprises a main body in the form of a hollow cylinder, and on at least one end surface thereof, means by which the laminated core can be attached to the inside surface of the housing of the splash-cooled electrical machine or to a rotor bracket of the rotor. This makes it possible for the injected oil to cool the laminated core in a simple but highly effective manner.

In particular, the laminated core of the stator can be attached to the interior housing of the splash-cooled electrical machine by the attachment means provided on at least one end surface of the laminated core. The housing can have an additional stator bracket, to which at least one end surface of the stator's laminated core is attached. The lateral surfaces of the stator's laminated core are exposed and can thus be cooled easily and effectively by the injected oil.

The same also applies to the inventive laminated core of the rotor. The laminated core of the rotor is mounted by at least one of its end surface on the rotor bracket. As a result, the lateral surfaces of the rotor's laminated core are exposed and can be cooled easily and effectively by the oil. To ensure that the laminated core can be attached reliably, means of attachment are provided on at least one side of the core.

The means of attachment provided on the stator's laminated core make it possible for the core to be attached directly to the inside surface of the housing. There is no longer any need, according to the invention, for a stator bracket. The oil can thus exert a more direct and more effective cooling action on the stator's laminated core. The same is also true for the laminated core of the rotor. Because the means of attachment attaches the rotor's laminated core by at least one end surface to the rotor bracket, the oil can exert a more direct and thus more effective cooling action on the rotor's laminated core.

One possible way of attaching the laminated core of the stator to the inside surface of the housing is to provide a positive connection between the laminated core of the stator and the housing of the splash-cooled electrical machine. It is advantageous, however, for the means by which the stator's laminated core is attached to be designed in such a way that a nonpositive and/or material connection is established between at least one end surface of the laminated core of the stator and the inside surface of the housing of the splash-cooled electrical machine. The means of attachment can be, for example, welds or clamping or latching devices.

In a suitable embodiment, the means of attachment are bores in the end surface of the laminated core of the stator. The bores serve to hold screws. The hollow cylindrical laminated core of the stator advantageously has a plurality of bores, which are offset from each other. The laminated core of the stator is thus fastened detachably to the housing of the splash-cooled electrical machine or to the stator bracket by the use of appropriate screws, which pass through holes or bores in the housing of the splash-cooled electrical machine or stator bracket and into the bores in the end surface of the laminated core of the stator. Appropriate seals ensure a leak-tight connection.

Also preferred is a laminated stator core in which the bores are axially parallel to the center axis of the hollow cylindrical laminated core of the stator. This leads to an effective and durable attachment. In the case of thin, hollow, cylindrical laminated stator cores, the fastening screws can be screwed deeply into the laminated core of the stator and thus ensure that the laminated core will remain firmly seated on the interior surface of the housing.

A hollow cylindrical laminated stator core is preferred in which the bores proceed from one end surface to the other all the way through the laminated core. As a result, the fastening screws can pass through the entire length of the laminated core of the stator, which provides a simple and reliable attachment of the stator's laminated core to the housing or to the stator bracket of the housing of the splash-cooled electrical machine. Seals can be provided between the end surface of the laminated core of the stator and the housing or the stator bracket of the housing of the splash-cooled electrical machine. The fastening screws pass through the means of attachment, in this case the bores, of the laminated core of the stator, and then the appropriate nuts are tightened until a firm connection is established between the end surface and the housing or the stator bracket of the housing of the splash-cooled electrical machine. The laminated core of the stator can thus be attached permanently to the inside surface of the housing of the splash-cooled electrical machine by the screws screwed into the bores.

The lateral surface, especially-the inside lateral surface, of an inventive laminated stator core of this type for a splash-cooled electrical machine can be easily splashed with oil, so that the heat can be easily, cheaply, and effectively dissipated from the laminated core, i.e., so that the core can be cooled easily, cheaply, and effectively.

According to another preferred embodiment of the laminated stator core, the inside surface of the hollow cylindrical laminated core of the stator is provided with recesses. Recesses in the inside surface of the laminated core of the stator increase the area of the inside lateral surface of the laminated core. A larger inside lateral surface provides better heat exchange. The larger the inside lateral surface of the stator's laminated core, the more effectively the heat can be dissipated. A large number of recesses in the inside surface of the hollow cylindrical laminated core of the stator increases the surface area of the inside lateral surface proportionately. The recesses can be punched, for example, into the inside surface of the hollow cylindrical laminated core of the stator.

A hollow cylindrical laminated stator core is preferred in which the recesses are in the form of grooves, which are axially parallel to the center axis of the stator's laminated core or which extend along spiral paths. As a result, the arriving cooling oil is guided easily along these grooves to the end surfaces of the hollow cylindrical laminated core of the stator. This effective conveyance of the oil guarantees good circulation of the oil through the interior of the housing of the splash-cooled electrical machine.

According to an advantageous embodiment of the hollow cylindrical laminated core of the stator, the grooves extend all the way from one end surface to the other end surface of the hollow cylindrical laminated core of the stator. As a result, it is guaranteed that the cooling oil which is splashed onto the inside lateral surface of the hollow cylindrical laminated core of the stator flows to the end surfaces of the hollow core and then onward to the rotor and to the oil outlets in the housing of the splash-cooled electrical machine. The flow of oil is accelerated by the rotating or turning rotor. As a result of the guidance provided by the grooves, the cooling oil is carried away axially along the stator's laminated core.

According to another advantageous embodiment of the inventive laminated stator core, the grooves have an angled course. That is, the grooves have, for example, first the form of a left-handed thread and then the form of a right-handed thread, or vice versa. The inside diameter of the laminated core of the stator can also increase from the center of the laminated core to the end surfaces, which provides an additional boost to the flow of cooling oil toward the end surfaces.

The grooves can have any one of a wide variety of shapes or cross sections. The grooves on the inside lateral surface of the inventive laminated stator core preferably have a round, pointed, rectangular, or staircase-like cross section. By designing the grooves in this way, the area of the inside lateral surface of the inventive laminated stator core is increased, so that better cooling of the laminated stator core is possible.

A laminated stator core in which ribs projecting toward the center axis of the laminated core are provided on the inside surface of the hollow cylindrical laminated core is also advantageous. As a result, the area of the inside surface of the hollow cylindrical laminated core of the stator can be increased even more, with the result that the heat can be dissipated even more effectively. The ribs can have a wide variety of shapes or cross sections, as in the case of the grooves mentioned above.

In a preferred embodiment of the hollow cylindrical laminated core of the stator, the ribs are offset from each other. A plurality of ribs provides a larger surface area on the inside of the stator's laminated core. The ribs can be straight or slanted. As a result, straight or slanted channels are created on the inside surface of the laminated core of the stator, as a result of which the flow of oil can be effectively controlled.

According to another advantageous embodiment of the laminated stator core, the core has channels. These channels pass through the hollow cylindrical core, so that the cooling oil can absorb heat in the interior of the hollow cylindrical core and carry it away.

Also advantageous is a laminated core for a stator in which a projection aligned with the inside lateral surface of the laminated core is provided on at least one end surface. The projection formed on at least one end surface of the hollow stator core forms an integral part of the laminated core and has the same inside diameter as the hollow cylindrical laminated core but a smaller outside diameter. The stator windings of the stator are on the outside lateral surface of the projection. The means of attaching the hollow cylindrical laminated stator core to the inside surface of the housing or to the stator bracket of the housing are provided on the projection. The diameter of the projection can decrease as it extends away from the end surface.

It is also advantageous for the projection of the inventive hollow cylindrical laminated stator core to have channels which extend from the inside surface of the projection to the outside surface of the projection. As a result, the cooling oil can pass through the projection to the stator windings and to the rotor and thus to the oil outlets in the housing of the splash-cooled electrical machine.

It is advantageous for the inventive hollow cylindrical laminated core of the rotor to have means on at least one end surface by which it can be attached to the rotor bracket. When at least one end surface of the rotor's laminated core is attached to the rotor bracket, the laminated core can be cooled easily and effectively by the injected oil. The lateral surfaces of the rotor's laminated core remain exposed, so that the heat which develops can be transferred directly to the oil flowing by. The features listed for the laminated core of the stator can also be used in exactly the same way for the laminated core of the rotor and vice versa.

A laminated rotor core is preferred in which the means of attachment produce a nonpositive and/or self-substance connection between the minimum of one end surface of the laminated rotor core and the rotor bracket. The means of attachment can also be welds or clamping or latching devices.

A laminated rotor core is advantageous in which the means of attachment are bores in the end surface of the laminated core. The bores serve to hold screws. The hollow cylindrical laminated core of the rotor advantageously has a plurality of bores, which are offset from each other. By accepting appropriate screws, which pass through holes or bores in the rotor bracket and into the bores in the end surface of the laminated rotor core, the laminated rotor core is attached to the rotor bracket in a detachable manner. Corresponding seals ensure a leak-tight connection. The holes or bores in the rotor bracket are in alignment with, or coaxial to, the bores in the laminated rotor core.

Also preferred is a laminated rotor core in which the bores are axially parallel to the center axis of the hollow cylindrical laminated core of the rotor. As a result, an effective and durable attachment is created. In the case of thin, hollow cylindrical laminated rotor cores, the fastening screws can be screwed deeply into the rotor's laminated core and thus ensure that the laminated core remains seated firmly on the rotor bracket.

Depending on how the splash-cooled electrical machine is designed, i.e., on how its components are arranged in the interior of the housing of the splash-cooled electrical machine, it is can be advantageous to provide recesses and/or ribs on the inside and/or outside lateral surface of the hollow cylindrical laminated rotor core. These recesses or ribs can serve to hold the windings on the lateral surface of the laminated rotor core or to improve the discharge of the cooling oil.

A laminated rotor core in which the core has channels is also advantageous. These channels are arranged in the interior of the core in such a way that the cooling oil can flow through the channels. This makes it possible for the heat to be dissipated more effectively.

The object is also accomplished by a splash-cooled electrical machine with a housing with oil outlets; with a stator, which is mounted inside the housing and has a hollow cylindrical laminated core; with a rotor, which is mounted inside the housing, is supported with freedom to rotate, and has a hollow cylindrical laminated core; and with a shaft with devices for injecting oil into the interior of the housing of the electrical machine, where the stator has a previously mentioned inventive laminated core and/or the rotor has a previously mentioned inventive laminated core.

A splash-cooled electrical machine of this type, which has a previously described inventive laminated core, represents a simple and powerful splash-cooled electrical machine. The cooling of the components inside the electrical machine can be accomplished directly and therefore effectively, so that the power of an electrical machine of this type and its aging resistance can be increased without having to change the outside dimensions of the electrical machine. In a splash-cooled electrical machine of this type, the cooling oil is splashed onto the inventively designed inside lateral surface of the laminated stator core by an injection device mounted on the shaft of the electrical machine. By means of the previously described design of the inside lateral surface, the laminated core of the stator is cooled with an especially high degree of efficiency. The oil which absorbs the heat flows to the end surfaces of the stator's laminated core and is conducted from there onto the stator windings and onto the rotor, especially the laminated core of the rotor, before it is conducted via outlets in the housing of the splash-cooled electrical machine to the oil circuit. The heated oil is cooled in a cooler and then sent back by a pump to the injection device. In splash-cooled electrical machines of this type, the stator and the rotor can thus be cooled simply and effectively with oil. There is no need for making provisions for a second medium in a connected gearbox, which makes it possible to lower costs.

It is advantageous to have a splash-cooled electrical machine in which the housing has means for a nonpositive and/or self-substance connection of the end surface of the laminated stator core to the inside surface of the housing. The means of attachment can be welds or clamping or latching devices.

Preferred is a splash-cooled electrical machine in which the means are bores for accepting screws passing through the housing, these bores being coaxial to the bores in the stator's laminated core. The bores through the housing are aligned with the bores in the stator's laminated core. Nuts can be tightened onto the screws introduced through the bores, so that the laminated core of the stator is seated firmly on the housing of the splash-cooled electrical machine. Seals can also be provided to seal the screwed joints.

What was said above concerning the laminated core of the stator applies similarly to the laminated core of the rotor and to the splash-cooled electrical machine and vice versa.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Additional details and advantages of the device can be derived from the following description and from the associated drawings, which show the necessary details of the preferred devices.

FIG. 1 shows a cross section of a prior art splash-cooled electrical machine;

FIG. 2 shows an inventive laminated core of a stator or of a rotor of a splash-cooled electrical machine;

FIG. 3 shows a cross section through an inventive laminated core of a stator or of a rotor of a splash-cooled electrical machine;

FIG. 4 shows a cross section through an inventive laminated core of a stator or of a rotor of a splash-cooled electrical machine;

FIGS. 5a-5d show cross sections of recesses in the inside lateral surface of an inventive laminated core of a stator or of a rotor of a splash-cooled electrical machine; and

FIG. 6 shows a cross section through a splash-cooled electrical machine with an inventive laminated stator core.

### DETAILED DESCRIPTION OF THE PRESENTLY PREFERRED EMBODIMENTS

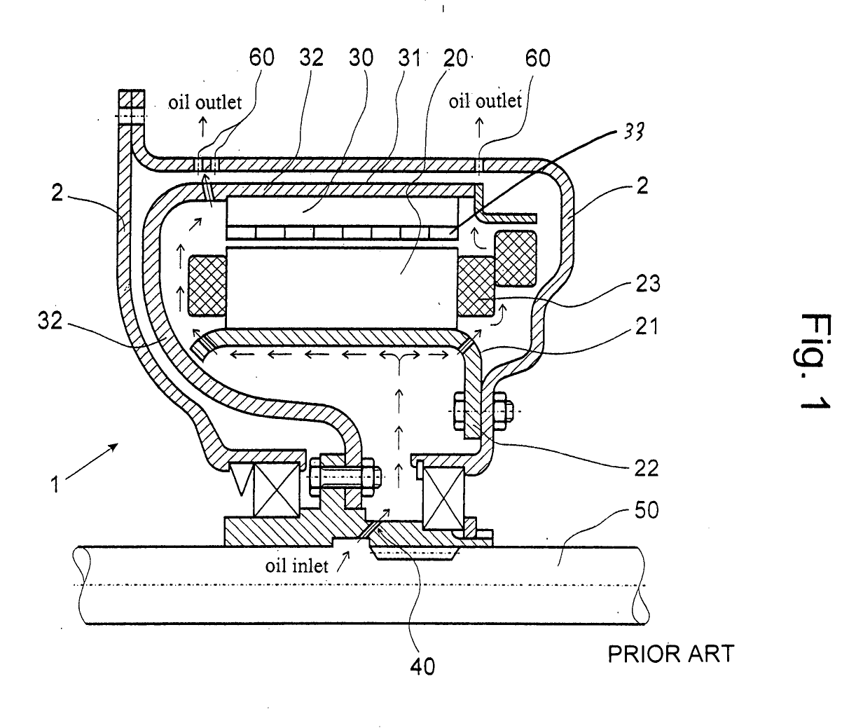

FIG. 1 shows a cross section of a prior art splash-cooled electrical machine 1. The stator 21 has a stator bracket 22, a laminated core 20, and windings 23 on the sides of the laminated core 20; the rotor 31 has a rotor bracket 32, a laminated core 30, and windings 33 around the lateral surface of the laminated core 30. The stator and the rotor are both mounted inside the housing 2 of the splash-cooled electrical machine 1. The shaft 50, on which the rotor 31 is mounted, ensures that the rotor 31 can rotate around the stator 21. The shaft 50 has a device 40 for injecting the oil. The oil strikes the sides of the stator bracket 22, from which it travels to the rotor 31 and to the outlets 60 in the housing 2. In the splash-cooled electrical machine 1 shown in FIG. 1, the laminated cores 20, 30 of the stator 21 and of the rotor 31 are attached along their lateral surfaces to their respective brackets 22, 32. That is, the stator's laminated core 20 is attached by its inside lateral surface to the stator bracket 22, and the rotor's laminated core 30 is attached by its outside lateral surface to the rotor bracket 32. The stator bracket 22 and the rotor bracket 32 are thus located between the laminated cores 20, 30 and the coolant. The heat developing in the laminated cores 20, 30 cannot be transferred directly from the laminated cores 20, 30 to the coolant, that is, to the injected oil; instead, the heat must be transferred first to the stator bracket 22 and to the rotor bracket 32. When the laminated cores 20, 30 of a splash-cooled electrical machine 1 are attached to the stator bracket 22 and to the rotor bracket 32, respectively, in the manner known in the prior art, it is therefore possible to achieve only limited cooling of the laminated cores 20, 30, which impairs the efficiency and decreases the durability of these splash-cooled electrical machines 1.

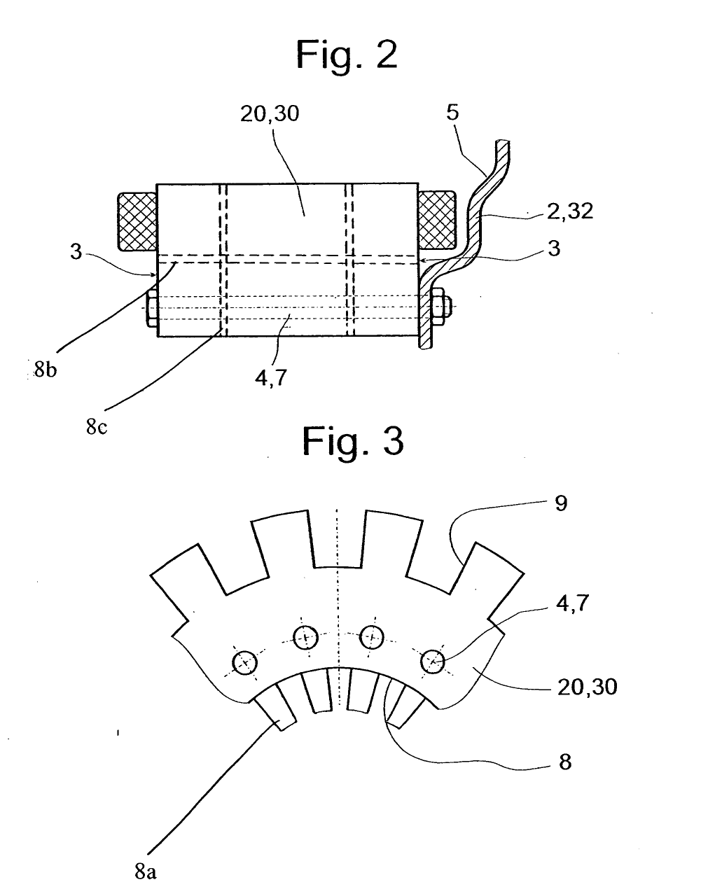

FIG. 2 shows an inventive laminated core 20, 30 of a stator 21 or of a rotor 31 of a splash-cooled electrical machine 1. The laminated core 20, 30 has means 4 by which at least one end surface 3 of the laminated core 20, 30 can be attached to the inside surface 5 of a housing 2 or to a rotor bracket 32 of a rotor 31. In this exemplary embodiment, the attachment means 4 are bores 7, which extend through the entire laminated core 20, 30 from one end surface 3 to the other end surface 3. These bores 7 are coaxial to, and in alignment with, bores in the housing 2 or bores in the rotor bracket 32 of a rotor 31 of the splash-cooled electrical machine 1. By means of screws, the laminated core 20, 30 is attached by its end surface 3 either to the inside surface 5 of a housing 2 or to the rotor bracket 32 of the rotor 31. A laminated core 20, 30 of this type for a stator 21 or for a rotor 31 can be easily and effectively cooled by injected oil. As mentioned earlier, the laminated core 20, 30 may have a plurality of spaced channels 8b, which preferably extend from one of the end surfaces 3 to the other of the end surfaces, and/or a plurality of spaced channels 8c, which extend from the inside lateral surface to the outside lateral surface.

FIG. 3 shows a cross section of an inventive laminated core 20, 30 of a stator 21 or of a rotor 31 of a splash-cooled electrical machine 1. The laminated core 20, 30 has means, here bores 7, by which at least one end surface 3 of the laminated core 20, 30 can be attached to the inside surface 5 of the housing 2 or to the rotor bracket 32 of the rotor 31. The inside surface 8 or inside lateral surface of the laminated core 20, 30 is therefore exposed, so that the injected cooling oil can reach the laminated core 20, 30 directly and thus provide very effective cooling of the laminated core 20, 30. Recesses 9 are provided on the outside lateral surface of the laminated core 30 of the rotor, so that the outside lateral surface has a larger area to be cooled. As mentioned earlier, the inside lateral surface 8 may have a plurality of spaced ribs 8a each projecting toward the center axis.

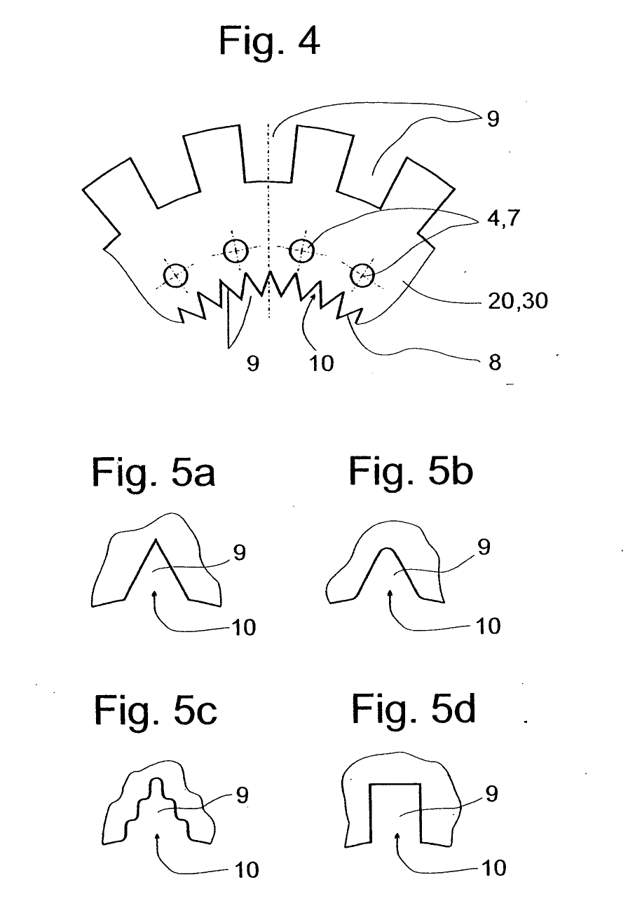

FIG. 4 also shows a cross section of an inventive laminated core 20, 30 of a stator 21 or of a rotor 31 of a splash-cooled electrical machine 1. In contrast to the laminated core 20, 30 in FIG. 3, this laminated core 20, 30 of a stator 21 or of a rotor 31 has recesses 9 in the form of straight grooves 10, which extend along the inside lateral surface with their axes parallel to the center axis of the laminated core 20, 30. As a result, the area of inside lateral surface 8 of the laminated core 20, 30 is increased, which means that the heat which develops can be conducted away more effectively.

FIGS. 5a-5d show various cross sections of the recesses 9, i.e., of the grooves 10, in the lateral surfaces of the inventive laminated core 20, 30.

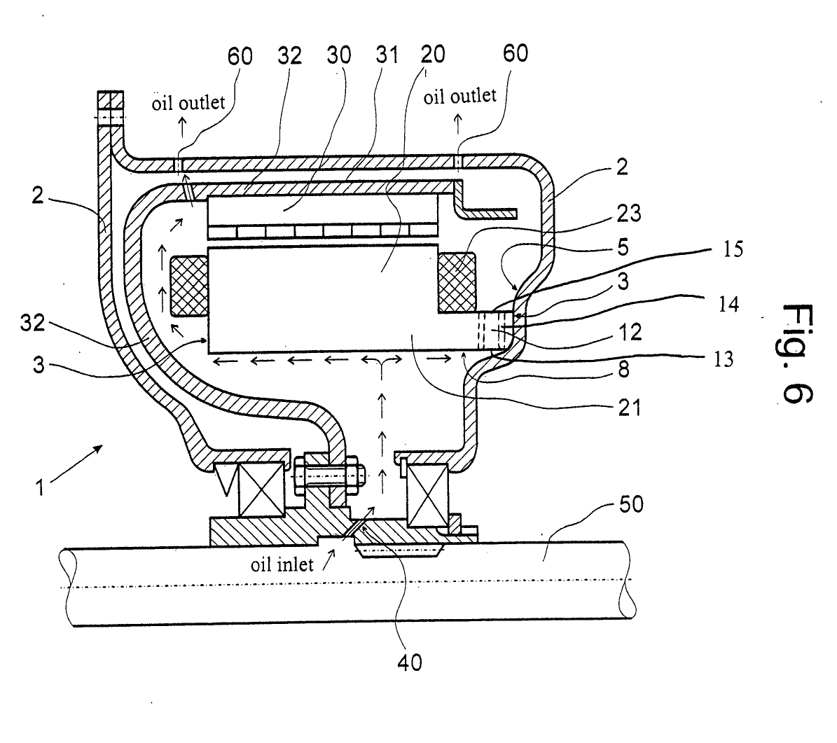

FIG. 6 shows the inventive splash-cooled electrical machine 1 with an inventive laminated stator core 20. The laminated core 20 of the stator is attached directly by one of its end surfaces 3 to the inside surface 5 of the housing 2 of the splash-cooled electrical machine 1. The attachment is produced by means of screws, which are screwed into bores in the laminated core 20 of the stator and into bores in the housing 2 of the splash-cooled electrical machine 1. The oil injected by the oil-injecting device 40 strikes directly the inside lateral surface 8 of the laminated core 20 of the stator. The laminated core 20 of the stator can thus be cooled very effectively by the arriving oil. The stator's laminated core 20 in this exemplary embodiment has a projection 12 on the end surface 3. This projection 12 is an integral part of the laminated core 20. The bores 7 in the laminated core 20 extend through the projection 12. The inside lateral surface of the laminated core 20 is aligned with the projection 12. The outside diameter of the projection 12 is smaller than the outside diameter of the laminated core 20 of the stator. The stator windings 23 are wrapped around the outside lateral surface of the projection 12. The projection 12 can have oil channels 15, which pass from the inside surface 13 of the projection 12 to the outside surface 14 of the projection 12.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A laminated core of a stator or a rotor for a splash-cooled electrical machine having a housing, the laminated core comprising:
a hollow cylindrical main body having a center axis, an outside lateral surface, an inside lateral surface, and two end surfaces; and
an attachment means on at least one of the two end surfaces via which the laminated core can be attached to a respective inside surface of the housing or a respective rotor bracket of the rotor inside the housing.

2. The laminated core of claim 1, wherein the attachment means is operable to establish a non-positive or material connection between the at least one of the two end surfaces and the inside surface of the housing.

3. The laminated core of claim 1, wherein the hollow cylindrical main body has a bore terminating at the at least one of the two end surfaces, and the attachment means is the bore.

4. The laminated core of claim 3, wherein the bore is axially parallel to the center axis.

5. The laminated core of claim 4, wherein the bore passes through the hollow cylindrical main body from one of the two end surfaces to the other of the two end surfaces.

6. The laminated core of claim 1, wherein the inside lateral surface comprises a recess.

7. The laminated core of claim 6, wherein the recess is in the form of a groove axially parallel to the center axis or extending along a spiral path.

8. The laminated core of claim 7, wherein the groove extends from one of the two end surfaces to the other of the two end surfaces.

9. The laminated core of claim 7, wherein the groove has a slanted course.

10. The laminated core of claim 7, wherein the groove has a round, pointed, rectangular, or staircase-shaped cross-section.

11. The laminated core of claim 1, wherein the inside lateral surface comprises a rib projecting toward the center axis.

12. The laminated core of claim 1, wherein the inside lateral surface comprises a plurality of spaced ribs each projecting toward the center axis.

13. The laminated core of claim 1, wherein the hollow cylindrical main body further comprises a channel.

14. The laminated core of claim 1, further comprising a projection extending from one of the two end surfaces.

15. The laminated core of claim 14, wherein the projection comprises an outer lateral surface, an inner lateral surface aligned with the inside lateral surface of the hollow cylindrical main body, and a channel extending from the inner surface of the projection to the outer lateral surface of the projection.

16. A splash-cooled electrical machine comprising:
a housing comprising an oil outlet and an inside surface;
a stator mounted inside the housing and comprising a first hollow cylindrical laminated core;
a rotor mounted inside the housing and comprising a second hollow cylindrical rotor laminated core, the rotor being operable to rotate with respect to the stator; and
a shaft comprising means for injecting coolant into the housing,
wherein the first hollow cylindrical laminated core comprises a hollow cylindrical main body having a center axis, an outside lateral surface, an inside lateral surface, two end surfaces, and a first bore terminating at the at least one of the two end surfaces.

17. The splash-cooled electrical machine of claim 16, wherein the housing has a connection means for establishing a non-positive or material connection between one of the end surfaces of the first hollow cylindrical laminate core and the inside surface of the housing.

18. The splash-cooled electrical machine of claim 17, wherein the connection means has a second bore passing through the housing and coaxial with the first bore in the first hollow cylindrical laminated core so that a screwed joint can be established via the first and second bores.
